(19) United States
(12) Patent Application Publication
(10) Pub. No.: US 2006/0085495 A1
(43) Pub. Date: Apr. 20, 2006

(54) Wireless input device

(75) Inventors: Pin-Chien Liao, Longtan Shiang (TW); Chien-Shih Hsu, Taipei (TW)

Correspondence Address: SNELL & WILMER;ONE ARIZONA CENTER, 400 EAST VAN BUREN, PHOENIX, AZ, 850040001, US

(73) Assignee: Darfon Electronics Corp.

(21) Appl. No.: 11/250,970

(22) Filed: Oct. 14, 2005

(30) Foreign Application Priority Data
Oct. 20, 2004 (TW) 093131793

(51) Int. Cl. G06F 15/02

(52) U.S. Cl. 708/131

(57) ABSTRACT

A wireless input device for controlling and inputting data to an electronic apparatus is provided. The wireless input device includes a housing, a first input unit, and a second input unit. The first and second input units are respectively on opposite sides of the housing, thereby connecting to the housing. The first input unit has a plurality of keys. The second input unit has a first key set and a second key set, each being disposed on a separate key face. The key sets are selectively situated to correspond to a position of the second input unit.

### CROSS-REFERENCE TO RELATED APPLICATIONS

This Application claims the right of priority based on Taiwan Patent Application No. 93131793 entitled “WIRELESS INPUT DEVICE,” filed on Oct. 20, 2004, which is incorporated herein by reference.

### FIELD OF INVENTION

The present invention relates to a wireless input device for controlling or inputting data to an electronic apparatus.

### BACKGROUND OF THE INVENTION

The continuous development of digital functions in electronic apparatus has resulted in more and more peripheral devices for supporting related manipulation of the functions. Conventionally, upon using electronic apparatus such as a TV, DVD, Home Theater System, Audio Integration, Media Gateway, etc., a remote controller is essential for user to remotely control the power or adjust any other specific functions of the electronic apparatus. For other electronic apparatus like a PC, PDA, etc., a keyboard can be additionally desirable in order to facilitate inputting of data. Hence, the interaction between the user and the electronic apparatus has gradually increased while more and more digital functions are integrated by information technology providers. For instance, when playing a Home Theater System, the performance thereof is adjustable according to a user's preferences by inputting data there into. However, traditional remote controllers with limited capability cannot satisfy user's requirement of rapidly inputting data. Alternatively, a keyboard can be used for solving such a problem. However, another inconvenience is subsequently caused by the extra space required by the keyboard. It is therefore desirable to create a novel multi-functional input device.

### SUMMARY OF THE INVENTION

The present invention provides a wireless input device for controlling or inputting data into an electronic apparatus, wherein a first input unit and a second input unit are integrated into the wireless input device, so that the user can remotely control the electronic apparatus and rapidly input data into the apparatus.

In accordance with the present invention, a wireless input device for controlling or inputting data into an electronic apparatus includes a housing, a first input unit, and a second input unit. The first input unit and the second input unit are respectively set on a first side and a second side of the housing. The first input unit has a plurality of keys for controlling the electronic apparatus. The second input unit has a first key set and a second key set. A first state of the wireless input device is defined when the first key set and the second key set are stacked and received into the housing concurrently with said first key face and said second key face facing the same direction. A second state of the wireless input device is defined when the first key set and the second key set are extended out of said housing in a sliding manner concurrently with the first key set and the second key set being substantially positioned on the same plane, so as to facilitate the user inputting data into the electronic apparatus.

Moreover, a wireless input device in accordance with the present invention further includes a control circuit, a memory component, a transmit unit, a display component, and a data transmitting key. The first input unit, the second input unit, the memory component, the transmit unit, and the display component respectively couple with the control unit. The data being inputted through the second input unit is cached by the memory component and presented on the display component. When the data transmitting key is activated, the data is sent to the electronic apparatus through the transmit unit.

### BRIEF DESCRIPTION OF THE DRAWINGS

FIG. 1A is a front view illustrating a wireless input device in a first state in accordance with the present invention.

FIG. 1B is a rear view illustrating a wireless input device in a first state in accordance with the present invention.

FIG. 1C is a side view illustrating a wireless input device in a first state in accordance with an embodiment of the present invention.

FIG. 2A is a front view illustrating a wireless input device in a second state in accordance with an embodiment of the present invention.

FIG. 2B is a rear view illustrating a wireless input device in a second state in accordance with an embodiment of the present invention.

FIG. 2C is a side view illustrating a wireless input device in a second state in accordance with an embodiment of the present invention.

FIG. 3 is a block diagram of a wireless input device in accordance with an embodiment of the present invention.

FIG. 4 is a rear view illustrating a wireless input device in a second state in accordance with yet another embodiment of the present invention.

### DETAILED DESCRIPTION

The present invention provides a wireless input device used for controlling or inputting data into an electronic apparatus. The electronic apparatus can be a television, videocassette recorder, computer, media gateway, STB (set top box), etc.; and the wireless input device can be an appliance that integrates the functions of a remote controller and a keyboard for the electronic apparatus as aforementioned. The wireless input device includes a housing, a first input unit, and a second input unit. In accordance with an embodiment of the present invention, the first input unit is a remote controller having a plurality of keys for selecting channels and/or controlling normal functions such as sound volume, brightness, etc. The second unit is a keyboard for computer, the keyboard having a plurality of keys for inputting complicated data such as characters or alphabetic strings. The first and the second input units are respectively set on the separate sides of the housing so as to integrate into a multiple-function remote controller.

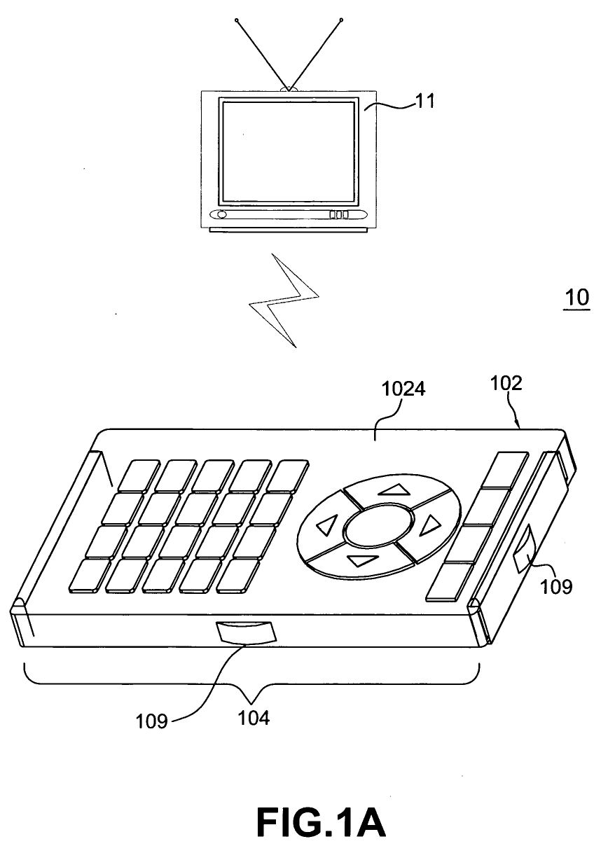

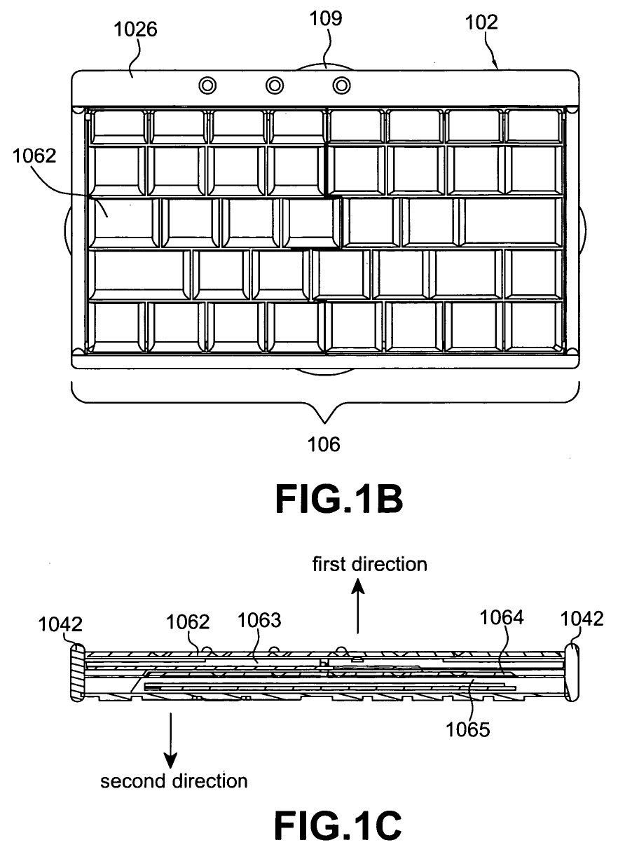

Referring to FIG. 1A, a wireless input 10 includes a housing 102 and a first input unit 104 connecting with the housing 102. The first input unit 104 on a first side 1024 provides a plurality of keys for controlling an electronic apparatus 11. The wireless device 10 further includes a transmit unit 109 for communicating with the electronic apparatus. The transmit unit 109 can be of any conventional type. In accordance with an embodiment of the present invention, the transmit unit is an IR transmitter, the electronic apparatus 11 is a television, and the first input unit 104 is a remote controller for selecting channels and/or controlling normal functions like sound volume, etc. It should be noted that the present invention is illustrated by way of example rather than limitation.

Referring to FIG. 1B, the wireless input device 10 includes a second input device 106 on a second side 1026 of the housing 102, such that the second input device 106 is connected with the housing 102. The second input device 106 includes a first key set 1062 and a second key set 1064. A first state of the wireless input device is defined when only the first key set 1062 of the second input unit 106 is exposed. Specifically, in accordance with an embodiment of the present invention, the second input device 106 is a foldable keyboard for computer, and the first state is when only a part of keys on the foldable keyboard (i.e. the first key set 1062) are exposed since the other part of keys (i.e. the second key set 1064) are underneath the first set. In addition, the transmit unit 109 for transmitting data from the second input unit 106 can be positioned on the sidewall 1042 of the housing 102.

Referring to FIG. 1C, the first key set 1062 and the second key set 1064 are stacked and received into the housing 102 when the wireless input device 10 is in the first state. The first key set 1062 forms a first key face 1063; and the second key set 1064 forms a second key face 1065. As aforementioned, the first key set 1062 and the second key set 1064 respectively includes a plurality of keys. In accordance with the illustrated embodiment, the first key face 1063 and the second key face 1065 are oriented towards a first direction. Likewise, the plurality of keys on the first key set 1062 and the second key set 1064 are also oriented towards the first direction, which is opposite to the second direction oriented by the plurality of keys of the first input unit 104 on the housing 102. The wireless device 10 in the first state takes less space compared with that in a second state to be described hereafter because the first key set 1062 and the second key set 1064 are received into the housing 102 in a stacking manner.

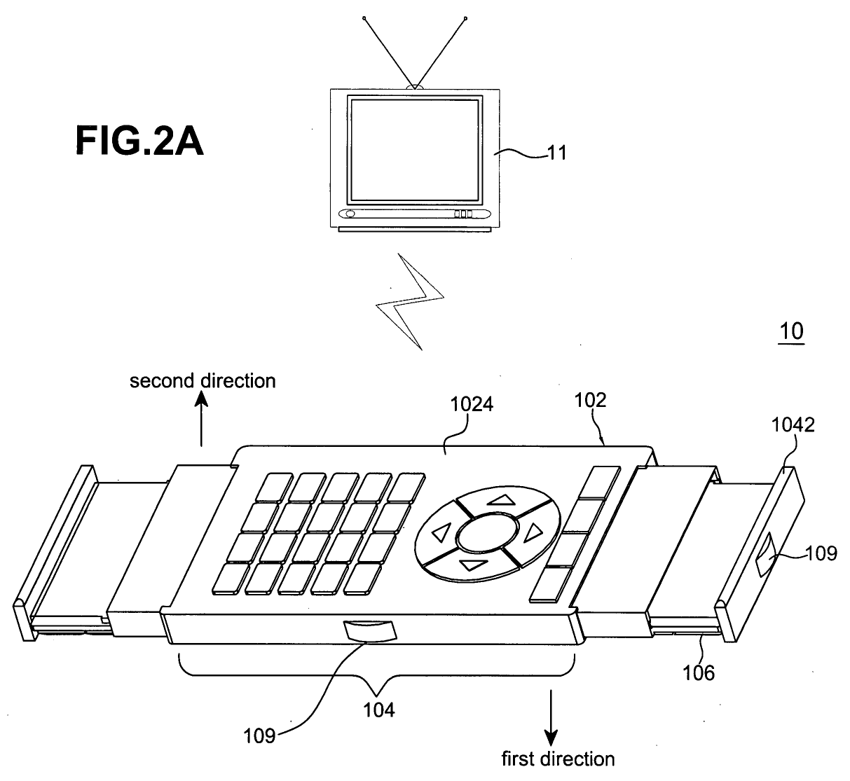

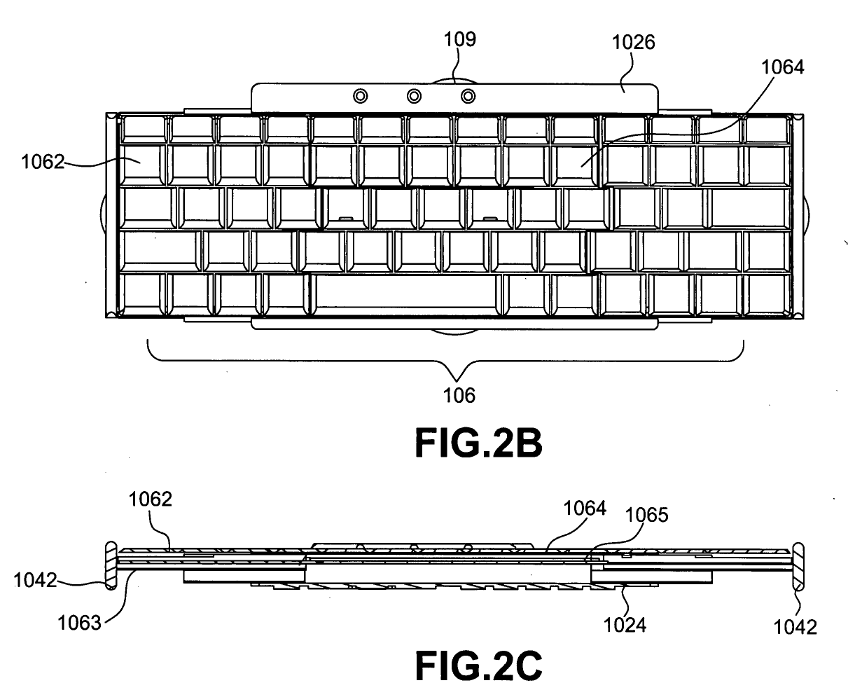

Referring to FIG. 2A, the second state of the wireless device 10 is defined when the second input unit 106 is extended out of the housing 102, such that the second input unit 106 occupies a space wider than that of the first input unit 104. Further referring to FIG. 2B, when the wireless device 10 is in the second state, the second input unit 106 is unfolded and retracted out of the housing 102 by extending the first key set 1062 out of the housing 102 in a sliding manner and raising the second key set 1064 up from the housing 102. As a result, the first key set 1062 and the second key set are substantially situated on the same plane. Meanwhile, as aforementioned, the plurality of keys of the first and second key sets are oriented towards the first direction, which is opposite to the second direction oriented by the plurality of keys of the first input unit 104. The wireless device 10 of the present invention can enhance the user's convenience as well as reduce the space previously occupied by devices that performed similar functions. In accordance with one embodiment of the invention, the transmit unit 109 on the sidewall 1042 will be activated automatically when the second input unit 106 is in the operation state (i.e. the second state). The data transportation can be smoother if the transmit unit 109 to be activated is close to the receptor of the electronic apparatus 11.

Referring to FIG. 2C, the first input unit 104 includes the two side walls 1042 protruded out of the surface constituted by the plurality of keys on the first side 1024, so as to avoid the plurality of keys on the first side 1024 being mistakenly pressed when the second input unit 1064 is in the second state. Specifically, when the wireless input device 10 in the second state is placed on a table, the two sidewalls 1042 will contact with the surface of the table and hold the wireless device 10 as well, so as to prevent the plurality of keys of the first input unit 104 from being affected during the inputting operation of the second input unit 106.

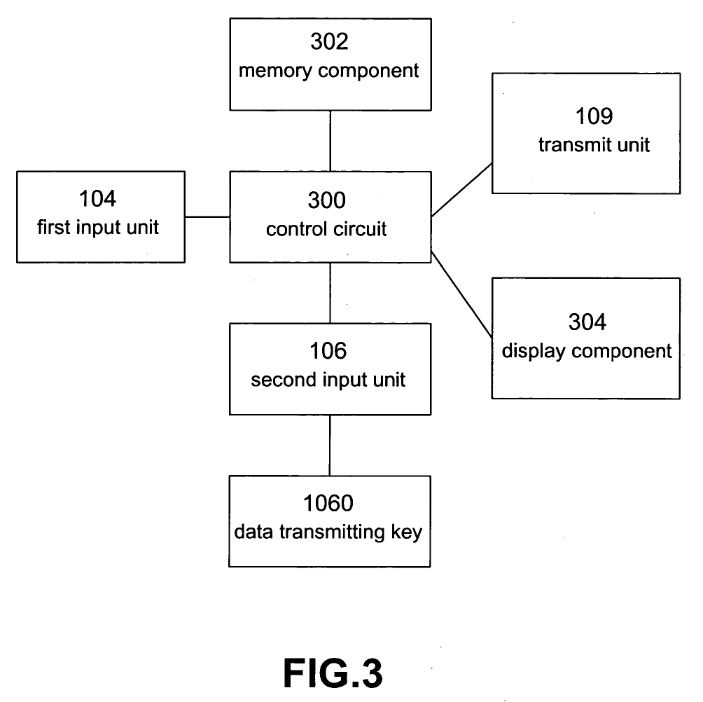

Now Referring to FIG. 3, the present invention further includes a control circuit 300, a memory component 302, a display component 304, and a data transmitting key 1060. The control circuit 300 couples with the first input unit 104, the second input unit 106, and the transmit unit 109 respectively. The control circuit 300 receives data from the first input unit 104 or the second input unit 106, then sends the data to the electronic apparatus 11 through the transmit unit 109, so as to control and/or input data to the electronic device 11. The wireless device 10 further includes the memory component 302 and the display component 304, both coupling with the control unit 300. The memory component 302 caches data being inputted through the second input unit 106. The display component 304 presents data cached by the memory component 302.

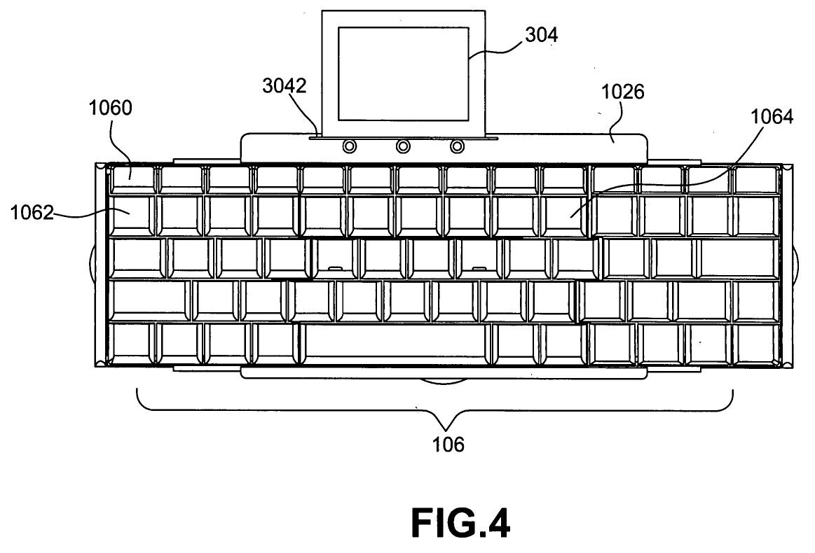

Referring to FIG. 4, when the wireless device 10 is in the first state, the display component 304 can be collapsed to be close to the second side 1026 such that the display component 304 can be received in the wireless device 10. Upon operation, the display component 304 can be erected up by turning it away from the second side 1026. In addition, the wireless input device further includes the data transmitting key 1060 for activating the control circuit 300 to transfer the data cached by the memory component 302 into the electronic apparatus 11. In other words, in accordance with the present invention, a user can input or edit data by utilizing the second input device, and then the memory component 302 caches the data which is read by the display component 304. At the moment that the data transmitting key is activated, the data cached by the memory component will be sent to the electronic apparatus 11 by the transmit unit. The display component 304 is an LCD monitor in accordance with an embodiment of the present invention.

The present invention has been described above with reference to preferred embodiments. However, those skilled in the art can understand that the scope of the present invention is not to be limited to the disclosed preferred embodiments. On the contrary, it is intended to cover various modifications and equivalent arrangements within the scope defined in the following appended claims. The scope of the claims should be accorded the broadest interpretation so as to encompass all such modifications and equivalent arrangements.

1. A wireless input device for controlling or inputting data into an electronic apparatus, said wireless input device comprising:
a housing;
a first input unit on a first side of said housing and connecting to said housing; and
a second input unit on a second side of said housing, said second input unit comprising a first key set with a first key face, and a second key set with a second key face,
wherein, a first state is defined when said first key set and the second key set are stacked and said first key face and said second face are oriented towards a first direction; and
a second state is defined when said first key set extends out of said housing in a sliding manner.

2. The wireless input device of claim 1, wherein said first side is oriented towards a second direction opposite to said first direction.

3. The wireless input device of claim 1, wherein said first input unit further comprises a plurality of keys and two side walls protruding out of a surface constituted by said plurality of keys so as to prevent said plurality of keys from being mistakenly pressed when said device is in said second state.

4. The wireless input device of claim 1, wherein said first key face and said second key face are substantially on the same plane.

5. The wireless input device of claim 1, further comprising:
a control circuit, coupling with said first input unit and said second input unit; and
a transmit unit, coupling with said control circuit;
wherein said control circuit receives data from said first input unit or said second input unit and sends the data to said electronic apparatus through said transmit unit.

6. The wireless input device of claim 5, further comprising:
a memory component, coupling with said control unit, said memory component caching data from said second input unit; and
a display component, coupling with said control unit, said display component presenting data cached by said memory component.

7. The wireless input device of claim 6, further comprising a data transmitting key, wherein said control unit sends the data cached by said memory component to said electronic apparatus when said data transmitting key is activated.
